(19) United States
(12) Patent Application Publication
(10) Pub. No.: US 2008/0078860 A1
(43) Pub. Date: Apr. 3, 2008

(54) Rotating wing apparatus

(76) Inventor: Phillip Createman, Jamul, CA (US)

Correspondence Address: CHARMASSON, BUCHACA & LEACH, LLP, 1545 HOTEL CIRCLE SOUTH, SUITE 150, SAN DIEGO, CA, 92108-3426, US

(21) Appl. No.: 11/518,966

(22) Filed: Sep. 11, 2006

(51) Int. Cl. B64C 33/00

(52) U.S. Cl. 244/22

(57) ABSTRACT

A rotating wing apparatus comprises two identical rectangular flat panels, each panel having planar surfaces, and each panel having an axis of rotation that passes lengthwise through the middle of the panel such that the axis is parallel to and equidistant from the longer edges of the panel. The operation of the apparatus begins with the panels lying flat side-by-side, with a longer edge of each panel abutted against a longer edge of the other panel. The panels then “fold downwards” with respect to each other, hinging at the abutted longer edges, such that each panel rotates about its axis at the same rate as the other panel but in a direction opposite that of the other panel, and such that the axes move towards each other, until a surface of each panel comes flat against a surface of the other panel. From this point the abutted longer edges of the panels now separate from each other, and the other longer edges of the panels then abut and hinge upon each other, such that the axes now move away from each other, until the panels again lie flat side by side, at which point the apparatus would again look like it did at the beginning of the operation except with the positions of the edges and surfaces of each panel reversed, and the panels continuing to hinge at the longer edges. The panels continue to rotate in this manner.

### FIELD OF THE INVENTION

This invention relates to propellers, impellers, fans, turbines, and the like. More specifically, though not exclusively, the present invention relates to a rotating wing apparatus that can be used in a vehicle akin to a helicopter, instead of the large rotating blades used in a conventional helicopter. The rotating wing apparatus of the present invention can also be used like a turbine to generate electricity. The rotating wing apparatus of the present invention can also be used in place of impellers on boats, ships and submarines to improve their performance. The present invention may also be used for vacuum cleaners, self-primed pumps for water and other liquids, fans, within jet engines, hydro turbines, miniature planes and toys, etc.

### BACKGROUND OF THE INVENTION

Various types of wing apparatus exist. U.S. Pat. No. 1,532,902 entitled “Aeroplane” which issued to Immers discloses a pair of “mutually inter-engaging rotary sustaining elements” each consisting of multiple longitudinal plane surfaces arranged radially at equal angular intervals and mounted on a rotary shaft, the two shafts in the same horizontal plane. The plane surfaces are always separated from each other. The rotary shafts are stationary with respect to each other and to the fuselage.

U.S. Pat. No. 727,377 entitled “Flying Machine” which issued to Kaehler discloses multiple rectangular planar wings mounted on shafts which rotate like paddle wheels in opposite directions to each other, which is supposed to create a lifting effect. The wings are always separated from each other. The shafts are stationary with respect to each other and to the fuselage.

U.S. Pat. No. 5,899,408 entitled “Ornithopter” which issued to Bowers, Jr. discloses a single, long, flexible or hinged wing that flexibly or hingedly flaps. The wing is made of a mesh with individual cloth flaps each of which covers a hole in the mesh on the downstroke of the wing in order to push against the air under the wing. Each flap uncovers from the hole on the upstroke in order to allow air to pass from above the wing, through the wing to below the wing. The wing continues to flap thus downwards and upwards. This flapping operation propels the apparatus upwards and forwards. The parts of the wing rotate only partially. Each part of the wing touches another part of the wing only via fixed hinges. The far ends of each wing always remain separated from each other.

U.S. Pat. No. 4,139,171 entitled “Articulated Wing Ornithopter” which issued to Harris discloses two wings that hingedly flap. The outer segments of the wings pivot downward on the upstroke to allow air to pass by them, and pivot back up to horizontal position to push against the air under the wings on the downstroke. According to the disclosure this motion sustains the apparatus in the air. The parts of each wing rotate only partially. The one part of each wing touches the other part of the wing only via one fixed hinge. The far ends of each wing always remain separated from each other.

U.S. Pat. No. 1,726,342 entitled “Flying Machine with Flapping Wings” which issued to Cerny discloses two wings that jointedly flap up and down. Each wing also has a second joint which during the upward motion of the wing permits a jumping forward and a turning up movement of the wings, and during the downward motion of the wing a pulling back of the wing in an essentially horizontal direction. The parts of each wing rotate only partially. The one part of each wing touches the other part of the wing only via one fixed hinge. The far ends of each wing always remain separated from each other.

U.S. Pat. No. 3,439,887 entitled “Wing Rotor Control Apparatus” which issued to Boehler, et al. discloses wing rotors each of which can autorotate about its spanwise axis. Each wing rotor may have control plates pivotally mounted on its ends. In one embodiment the control plates are hinged in the middle and bend with respect to each other about the hinge. The plates provide control only and no lift. The plates rotate only partially. The outside edges of the plates are always separated from each other.

U.S. Pat. No. 3,380,689 entitled “Stabilizing System for Aircraft” which issued to Bucher discloses stabilizers for aircraft, each of which rotates about an axis and has openings each of which can be closed or re-opened by means of a folding hinged shutter or flap over the opening. The rotating stabilizers always remain separated from each other. The flaps over the stabilizer openings rotate only partially. Each of the flaps provides some lift but only as a conventional aviation flap. The unhinged edges of the flaps always remain separated from each other.

U.S. Pat. No. 4,596,367 entitled “Horizontal Wind/Water Wheel with Vertical Lift A Superior Protype Model” which issued to Wittwer discloses a rotary fluid-propelled device. The device has outer chambers having openings. The device rotates about an axis. The device has a strap that has four corners which, at maximum free lift force, provide fulcrum points at which the outer portions of the device bend upwards. Then the device bends at the top of its axis as its outer chambers twist their openings into line with each other. The surfaces of this device flex and/or hinge upon each other but otherwise remain fixed with respect to each other. The vertices between the surfaces hinge but remain fixed.

U.S. Pat. No. 1,864,012 entitled “Flying Machine” which issued to Dring discloses two conical three-bladed propellers, the wide ends of the cones facing away from each other, the propellers rotating about a common axis. The propellers produce drafts that collide with each other in the middle and push an aircraft up and forwards when the propellers are mounted on opposite sides of the aircraft fuselage. The surfaces of the propeller blades remain fixed with respect to each other and remain separated from each other.

U.S. Pat. No. 1,989,755 entitled “Vertically Reciprocating Winged Aviating Apparatus for Human Beings” which issued to Jelalian discloses a pair of curved wings that flap hinged to a sort of fuselage. The wings rotate only partially about the fixed hinges. The wings remain separated from each other.

U.S. Pat. No. 1,057,891 entitled “Propeller” which issued to Smith, et al. discloses two planar surfaces that hinge upon each other, and about the hinge continuously open and extend then close and retract, to propel a craft through fluid. The planar surfaces rotate only partially about the permanent hinge. The outer edges of the planar surfaces always remain separated from each other.

U.S. Pat. No. 2,333,171 entitled “Device for Propelling Boats” which issued to Gorr discloses a device which, from a craft, is manually pushed and pulled in fluid in which the craft floats. About the hinge the planar surfaces open when pushed and close when pulled, thus propelling the craft through the fluid. The planar surfaces rotate only partially about the permanent hinge. The outer edges of the planar surfaces remain separated from each other.

An object of the present invention is to provide a rotating wing apparatus that is more compact and provides lift more efficiently than preexisting disclosed technology. Another object of the present invention is to provide a rotating wing apparatus that has surfaces which temporarily touch or hinge upon each other. Yet another object of the present invention is to provide a rotating wing apparatus that has planar surfaces that completely rotate about their central longitudinal axes, and that allow their outer edges to hinge upon each other and then allow the inner edges to separate from each other in the process of rotation of the surfaces. Yet another object of the present invention is to provide a rotating wing apparatus that has panels having central longitudinal axes that move alternately together and apart in order to keep the panels in contact with each other as they rotate about their axes in opposite directions and alternately hinge upon each other at their edges.

### BRIEF SUMMARY OF THE INVENTION

The present invention is a rotating wing apparatus. In a preferred embodiment, the rotating wing apparatus of the present invention comprises two identical rectangular flat panels, each panel having planar surfaces, and each panel having an axis of rotation that passes lengthwise through the middle of the panel such that the axis is parallel to and equidistant from the longer edges of the panel. In the preferred embodiment, the operation of the apparatus begins with the panels lying flat side-by-side, with a longer edge of each panel abutted against a longer edge of the other panel. The panels then “fold downwards” with respect to each other, hinging at the abutted longer edges, such that each panel rotates about its axis at the same rate as the other panel but in a direction opposite that of the other panel, and such that the axes move towards each other, until a surface of each panel comes flat against a surface of the other panel. From this point the abutted longer edges of the panels now separate from each other, and the other longer edges of the panels then abut and hinge upon each other, such that the axes now move away from each other, until the panels again lie flat side by side, at which point the apparatus would again look like it did at the beginning of the operation except with the positions of the edges and surfaces of each panel reversed, and the panels continuing to hinge at the longer edges. The panels continue to rotate in this manner.

The rotating wing apparatus of the present invention is more compact and provides lift more efficiently than preexisting disclosed technology. The rotating wing apparatus of the present invention more efficiently generates and maintains pressure differentials on opposite adjacent sides of the rotating wing apparatus in order to generate lift.

### BRIEF DESCRIPTION OF THE DRAWING

The aforementioned and other advantages of the rotating wing apparatus of the present invention will become more apparent to those skilled in the art upon making a thorough review and study of the following detailed description of the invention when reviewed in conjunction with the drawings in which like references numerals refer to like parts, and wherein:

FIG. 1 is a perspective view of a preferred embodiment of the rotating wing apparatus of the present invention, showing the panels lying flat side-by-side and hinging at their longer edges, and showing an arm that controls the alternating spreading and coming together of the axes of the panels in order to keep the panels constantly in contact with each other while they are rotating;

FIG. 1A is a perspective view of an alternative embodiment of the rotating wing apparatus of the present invention, showing the panels lying flat side-by-side and hinging at their longer edges, and showing a pair of rotating wheels that controls the alternating spreading and coming together of the axes of the panels in order to keep the panels constantly in contact with each other while they are rotating;

FIG. 2 is a side view of the preferred embodiment of the rotating wing apparatus of the present invention showing the panels lying flat side by side and hinging at their longer edges;

FIG. 3 is another side view of the preferred embodiment of the rotating wing apparatus of the present invention showing the panels folding downwards with respect to each other, hinging at the longer edges;

FIG. 4 is another side view of the preferred embodiment of the rotating wing apparatus of the present invention showing the panels flat against each other;

FIG. 5 is another side view of the preferred embodiment of the rotating wing apparatus of the present invention showing the panels opening outwards with respect to each other, hinging at the longer edges;

FIG. 6 is a side view of a first alternative embodiment of the rotating wing apparatus of the present invention, showing the surfaces of the panels as wavy to increase the surface area of the two rotating panels;

FIG. 7 is a side view of a second alternative embodiment of the rotating wing apparatus of the present invention, in which the panels are replaced with two tubes that are triangular in cross section and are side-by-side such that surfaces of the tubes come together in operation;

FIG. 8 is a side view of the second alternative embodiment of the rotating wing apparatus of the present invention, taken in direction 8 of FIG. 7, showing surfaces of one of the tubes;

FIG. 9 is a side view of a third alternative embodiment of the rotating wing apparatus of the present invention, similar to that of FIG. 7 except the tubes are square in cross section instead of triangular, where the tubes are side by side such that surfaces of the tubes come together in operation;

FIG. 10 is a side view of the third alternative embodiment of the rotating wing apparatus of the present invention, taken in direction 10 of FIG. 9, showing a surface of one of the tubes;

FIG. 11A-D is a series of views showing the operation of a preferred embodiment of the rotating wing apparatus of the present invention showing the structure that retains the panels adjacent each other during the entire rotation process;

FIG. 12 is an end view of an alternative embodiment of the rotating wing apparatus of the present invention showing each panel equipped with a longitudinally placed brush which can minimize air passing between each wing panel; and

FIGS. 13A-D are a series of progressive images showing an alternative embodiment of the rotating wing apparatus of the present invention in various stages of rotation.

### DETAILED DESCRIPTION OF THE INVENTION

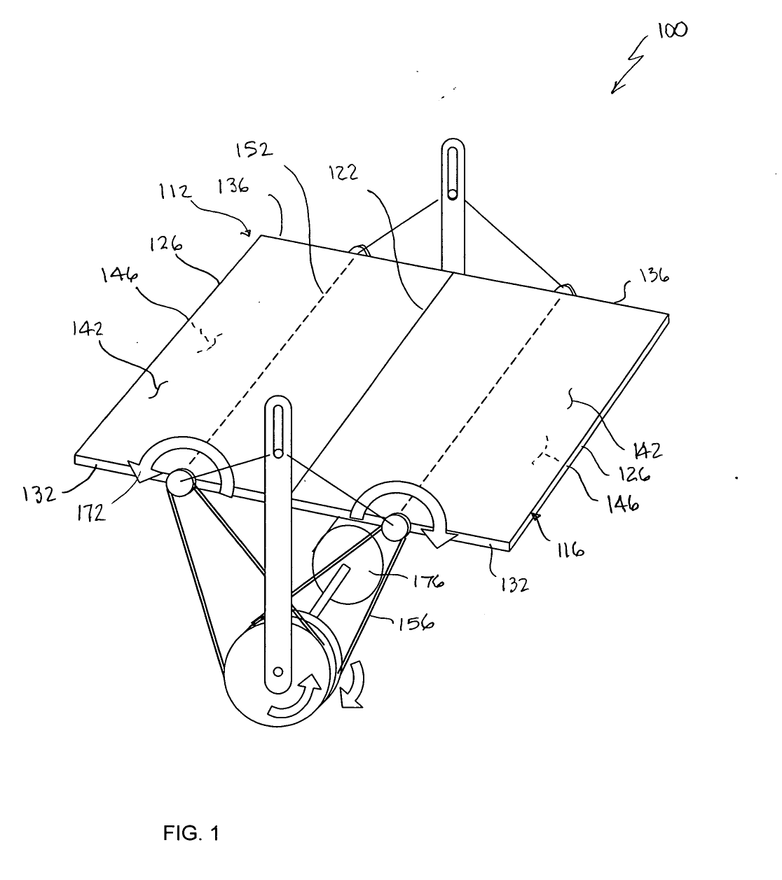

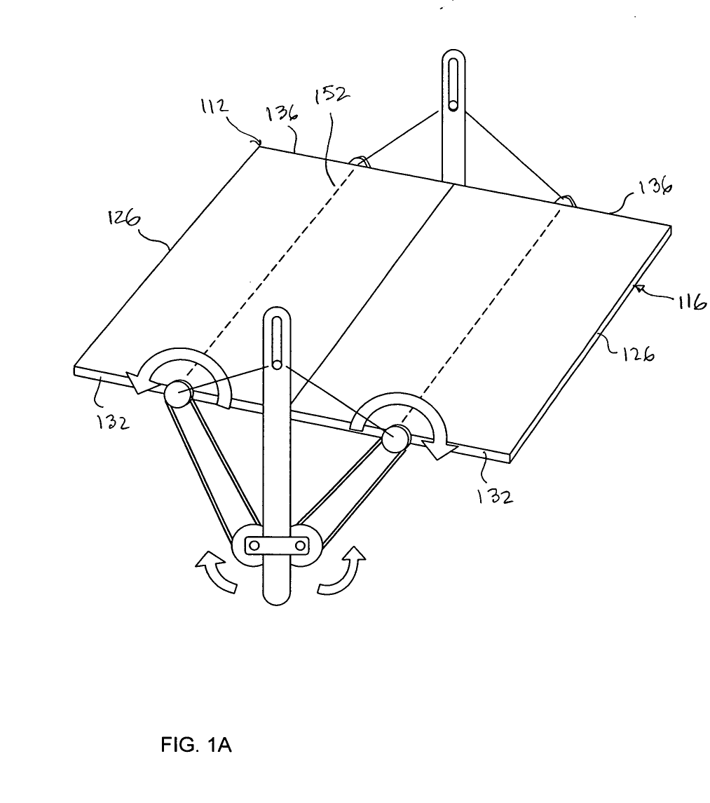

Referring initially to FIG. 1, a preferred embodiment of the rotating wing apparatus of the present invention, generally designated 100, comprises two panels 112 and 116. Each of panels 112 and 116 has a first long edge 122, a second long edge 126, a first short edge 132, a second short edge 136, a first planar surface 142, and a second planar surface 146. Panel 112 has a rotational axis 152 that passes substantially lengthwise through the middle of panel 112, such that the axis 152 is substantially parallel to and substantially equidistant from each of first long edge 122 and second long edge 126 of panel 112. Panel 116 has a rotational axis 156 that passes substantially lengthwise through the middle of panel 116, such that axis 156 is substantially parallel to and substantially equidistant from each of first long edge 122 and second long edge 126 of panel 116. FIG. 1 shows panels 112 and 116 lying flat side-by-side, temporarily hinging at their first long edges 122. This hinging action is further explained in connection with FIG. 2.

Panels 112 and 116 may be made of metal, wood, plastic, ceramic, or any other material capable of substantially retaining the form of the panels 112 and 116. Additional materials may include fiberglass, graphite resin, or any other material having the strength necessary to withstand the rotation al forces.

FIG. 2 is a side view of the preferred embodiment of the rotating wing apparatus of the present invention 100, taken in direction 2 in FIG. 1, showing panels 112 and 116 in a position such that first long edges 122 abut each other, first planar surfaces 142 are substantially coplanar, and second planar surfaces 146 are substantially coplanar. First long edges 122 temporarily hinge upon each other, as follows. Panel 112 has a tab 162 which runs at least part of the length of first long edge 122 of panel 112. Panel 116 has a channel 164 which runs at least part of the length of first long edge 122 of panel 116. Tab 162 is removably received in channel 164 in order to keep long edges 122 temporarily hinged upon each other. Panel 112 also has a channel 166 which runs at least part of the length of second long edge 126 of panel 112, and panel 116 has a tab 168 which runs at least part of the length of second long edge 126 of panel 116. Tab 168 and channel 166 inter-operate similarly to tab 162 and channel 164, as explained below. Additionally, each edge of each panel may be made of a magnetic material which would provide some adhesion between the panels during the rotation of the wing.

In operation, panel 112 continuously rotates about axis 152 in angular direction 172. Panel 116 rotates about its axis 156, at substantially the same rate as panel 112 but in angular direction 176 substantially opposite angular direction 172. In the positions shown in FIG. 2, axes 152 and 156 are substantially at their greatest distance of separation from each other. If operation of apparatus 100 begins in the position shown in FIG. 2, then as panels 112 and 116 rotate, they “fold downwards” with respect to each other, hinging at first long edges 122 as assisted by the hinging action of tab 162 in channel 164. Simultaneously, axis 152 moves in direction 182, and axis 156 moves in direction 184, such that axes 152 and 156 move towards each other.

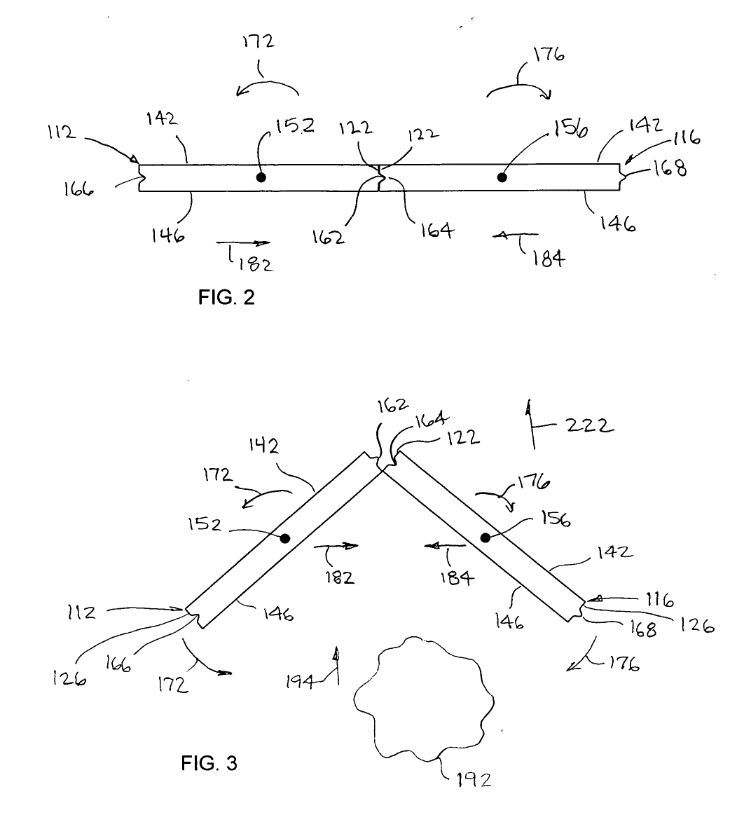

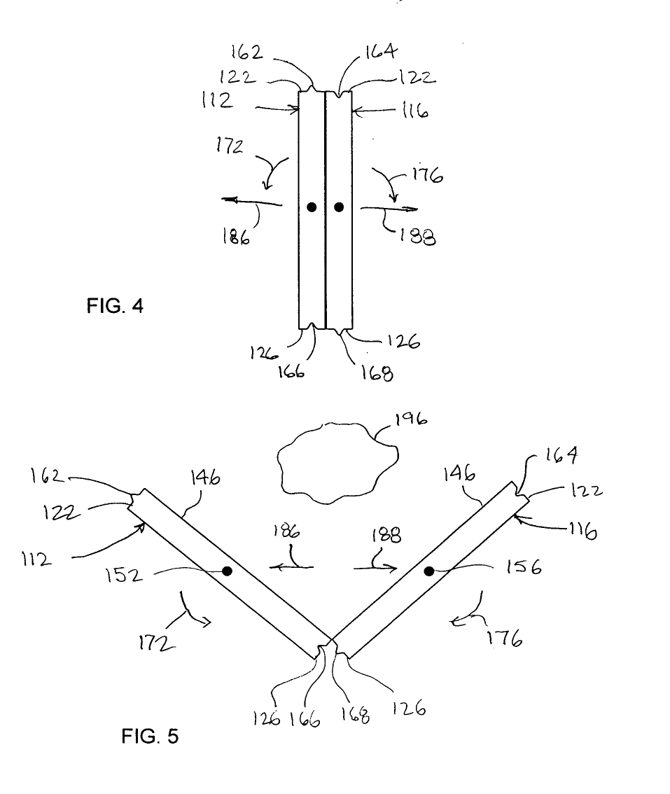

FIG. 3 shows panels 112 and 116 in the midst of this motion of “folding downwards” with respect to each other, hinging at first long edges 122, with axes 152 and 156 moving towards each other simultaneously with the rotation of panels 112 and 116. This motion causes second long edges 126 to move towards each other. This motion also causes tab 162 to withdraw from channel 164 so that the motion can continue until second planar surfaces 146 come substantially flat against each other, as shown in FIG. 4.

FIG. 4 shows panels 112 and 116 with second planar surfaces 146 flat against each other. In this position, axes 152 and 156 are substantially at their smallest distance of separation from each other. As panels 112 and 116 continue to rotate in their respective directions 172 and 176, panels 112 and 116 now “open apart” such that first long edges 122 move away from each other, second long edges 126 now hinge upon each other, and axes 152 and 156 move away from each other in directions 186 and 188, respectively.

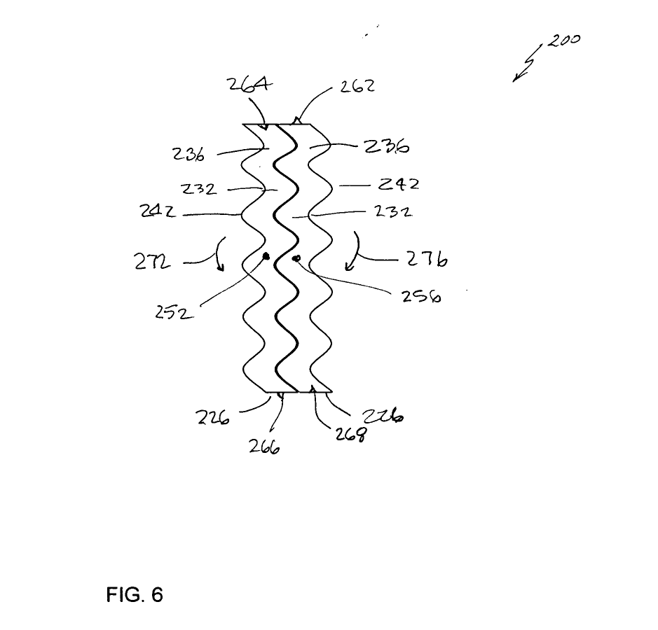

FIG. 5 shows panels 112 and 116 in the midst of this motion of “opening apart” at first long edges 122, hinging at second long edges 126, with axes 152 and 156 moving away from each other simultaneously with the “opening apart” of panels 112 and 116. This motion causes tab 166 to enter channel 168, which assists in the hinging of second long edges 126 upon each other. This motion continues until panels 112 and 116 are in the positions shown in FIG. 2 except that, for each of panels 112 and 116, the positions of surfaces 142 and 146 would be reversed with respect to each other, the positions of long edges 122 and 126 would be reversed with respect to each other, the positions of tab 162 and channel 166 would be reversed with respect to each other, and the positions of tab 168 and channel 164 would be reversed with respect to each other. In this position, axes 152 and 156 are once again substantially at their greatest distance of separation from each other.

The panels 112 and 116 continue to rotate in this manner, hinging at first long edges 122 through the interaction of tab 166 and channel 168, such that panels 112 and 116 “fold downwards”, axes 152 and 156 move towards each other, and second planar surfaces 146 come together flat against each other. In this position, panels 112 and 116 would look like they do in FIG. 4 except that, for each of panels 112 and 116, the positions of surfaces 142 and 146 would be reversed with respect to each other, the positions of long edges 122 and 126 would be reversed with respect to each other, the positions of tab 162 and channel 166 would be reversed with respect to each other, and the positions of tab 168 and channel 164 would be reversed with respect to each other. In this position, axes 152 and 156 are once again substantially at their smallest distance of separation from each other. In continued operation, panels 112 and 116 continue to rotate in this manner, hinging at long edges 122 and 126 alternately, simultaneously with axes 152 and 156 moving alternately together and apart.

The theory of operation is as follows. With reference to FIG. 2, when panels 112 and 116 “close together”, hinging at long edges 122 (or 126), this creates high pressure in a first space 192 adjacent panels 112 and 116 (high pressure means pressure higher than the ambient pressure), which creates on apparatus 100 a force having direction 194, which tends to push the apparatus 100 in direction 194. With reference to FIG. 5, the “opening apart” of the panels 112 and 116, hinging at long edges 126 (or 122), creates low pressure in the surrounding medium (air, water, etc.) in a second space 196 adjacent panels 112 and 116 (low pressure means pressure lower than the ambient pressure), which creates on the apparatus 100 another force having direction 194, which also tends to push the apparatus in direction 194. Thus, high pressure is repeatedly created in first space 192 adjacent the apparatus 100, and low pressure is repeatedly created in second space 196 adjacent the apparatus 100, such that the apparatus 100 is repeatedly pushed in direction 194. This operation is continued at a rate high enough to cause the apparatus 100 to be propelled in direction 194 through the medium of operation (air, water, etc.), or to be suspended in the medium of operation, or to fall through the medium of operation at a speed lower than would be caused by the force of gravity alone.

The medium in which the apparatus 100 operates to create the pressure differentials can be any fluid such as air or water, or other gas or liquid. The apparatus may also operate in flowing solids such as sand.

While each of long edges 122 and 126 is shown as having one tab 162 or 168 or one channel 164 or 166, each of long edges 122 or 126 can alternatively have more than one tab or more than one channel as long as the tabs and channels interface with each other to maintain the hinging action of the long edges 122 and 126.

While panels 112 and 116 are shown in FIGS. 1-5 as hinging at long edges 122 and 126, panels 112 and 116 can alternatively hinge at short edges 132 and 136. As yet another alternative, long edges 122 and 126 can be substantially the same length as short edges 132 and 136.

While long edges 122 and 126 and short edges 132 and 136 are shown in FIGS. 1-5 as being straight, any of long edges 122 and 126 and short edges 132 and 136 could alternatively be curved or jagged or of other shape as long as corresponding edges of panels 112 and 116 can hinge upon each other.

Alternative embodiments of the rotating wing apparatus of the present invention can include wing panels having cross-sections which represent rectangular, triangular and prism shapes. For instance, a wing panel having an equilateral triangular cross-section could provide for a wing panel having three edges.

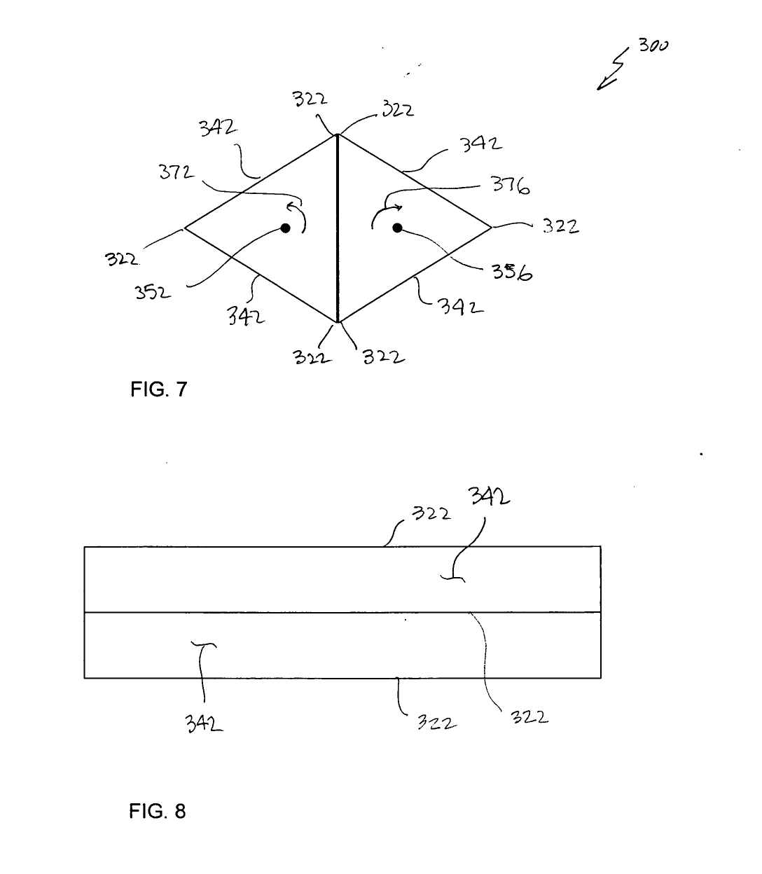

Referring now to FIG. 6, the rotating wing apparatus of the present invention can use many varieties of surfaces and shapes. In FIG. 6, a side view of a first alternative embodiment of the rotating wing apparatus of the present invention is shown and is generally designated 200. FIG. 6 is comparable to FIG. 4 except that in FIG. 6 apparatus 200 has wavy surfaces instead of planar surfaces 142 and 146 as in FIG. 4. As shown in FIG. 6, apparatus 200 has panels 212 and 216 each of which has a first long edge 222, a second long edge 226, a first short edge 232, a second short edge 236 (behind each of panels 212 and 216 as shown in FIG. 6), a first wavy surface 242 and a second wavy surface 246. The waviness of the surfaces 242 and 246 increases their surface area as compared to panels 112 and 116 having planar surfaces 142 and 146 as in FIG. 4.

As shown in FIG. 6, panel 212 also has a substantially central longitudinal rotational axis 252, and panel 216 has a substantially central longitudinal rotational axis 256. Panel 212 has a tab 262 which runs at least part of the length of first long edge 222 of panel 212. Panel 216 has a channel 264 which runs at least part of the length of first long edge 222 of panel 216. Panel 212 also has a channel 266 which runs at least part of the length of second long edge 226 of panel 212, and panel 216 has a tab 268 which runs at least part of the length of second long edge 226 of panel 216.

In operation, panel 212 continuously rotates about its central longitudinal axis 252 in angular direction 272; and panel 216 rotates about its central longitudinal axis 256, at the same rate as panel 216 but in angular direction 276 opposite angular direction 272. As panels 212 and 216 rotate, they hinge alternately at first long edges 222 and at second long edges 226. The hinging of first long edges 222 is assisted by the fact that tab 262 is removably received in channel 264 in order to keep long edges 222 temporarily hinged upon each other (similarly to the operation of apparatus 100 of FIG. 1). The hinging of second long edges 222 is assisted by the fact that tab 268 is removably received in channel 266 in order to keep second long edges 226 temporarily hinged upon each other (similarly to the operation of apparatus 100 of FIG. 1). Simultaneously, axes 252 and 256 alternately move together when surfaces 242 come together and when surfaces 246 come together; and axes 252 and 256 move apart from each other when surfaces 242 open away from each other and when surfaces 246 open away from each other (similarly to the operation of apparatus 100 of FIG. 1).

As shown in FIG. 6, the wavy surfaces 242 and 246 are formed so that the first wavy surface 242 of panel 212 substantially fits together with the first wavy surface 242 of panel 216 when these first wavy surfaces 242 substantially abut each other; and the second wavy surface 246 of panel 212 substantially fits together with the second wavy surface 246 of panel 216 when these second wavy surfaces 246 substantially abut each other; so as to effectively generate and maintain high pressure in first space 192 and low pressure in second space 196 in the medium adjacent apparatus 200 via its operation, in order to provide maximum lift in direction 194. FIG. 6 shows panels 212 and 216 with second wavy surfaces 246 substantially abutting each other and substantially fitting together. The waviness of the surfaces 242 and 246 increases their surface area as compared to panels 112 and 116 having substantially planar surfaces 142 and 146 as in FIG. 4. The increased surface area of surfaces 242 and 246 in FIG. 6 can increase the pressure differentials that can be generated in operation of apparatus 200 and thus increase the lift generated thereby.

While each of long edges 222 and 226 is shown as having one tab 262 or 268 or one channel 264 or 266, each of long edges 222 or 226 can alternatively have more than one tab or more than one channel as long as the tabs and channels interface with each other to maintain the hinging action of the long edges 222 and 226.

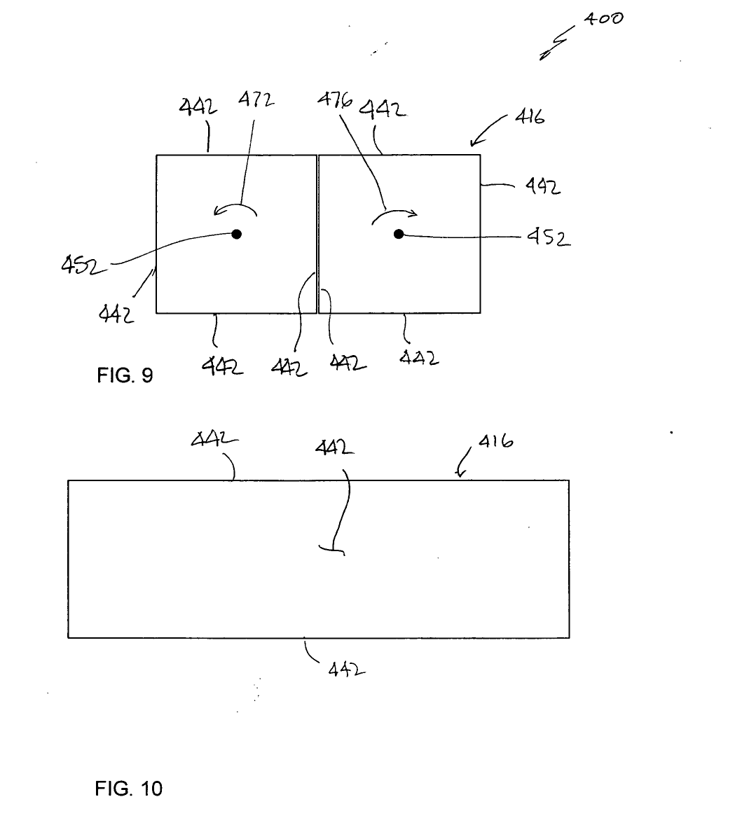

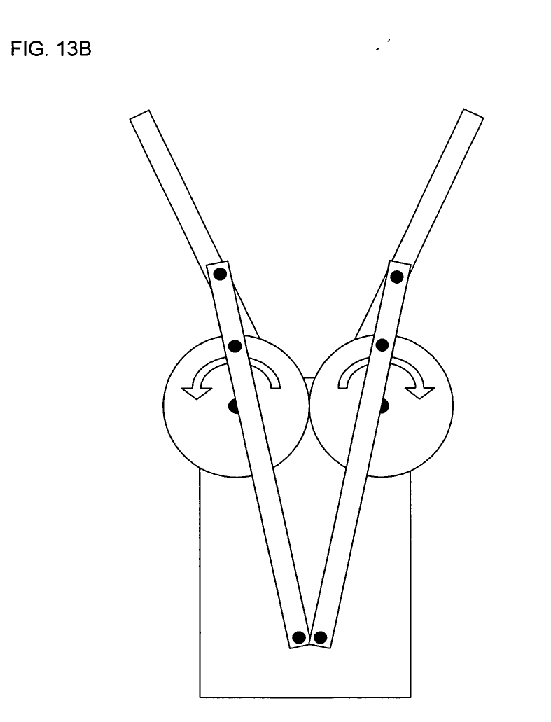

Turning now to FIG. 7, other possible embodiments include using tubes that have cross sections that are polygonal, e.g., triangular, square, pentagonal, hexagonal, etc., in place of the panels used in FIGS. 11-6.

FIG. 7 is a side view of a second alternative embodiment of the rotating wing apparatus of the present invention, generally designated 300. Apparatus 300 has two triangular tubes 312 and 316, instead of the panels 112 and 116 shown in FIG. 1. As shown in FIG. 7, triangular tubes 312 and 316 are triangular in cross section. Each of tubes 312 and 316 has vertices 322 and surfaces 342. In FIG. 7, surfaces 342 are shown as planar. Alternatively, surfaces 342 can be wavy or any other texture or shape that allows tubes 312 and 316 to rotate and remain substantially in contact with each other.

Tube 312 also has a central longitudinal rotational axis 352, and tube 316 has a central longitudinal rotational axis 356. Each vertex 322 of tube 312 may have either a tab 362 or channel 364 running the length of vertex 322. Each vertex 322 of tube 316 may have a channel 366 or tab 368 running the length of vertex 322 and corresponding to each tab 362 or channel 364 of tube 312.

Tubes 312 and 316 may be made of metal, wood, plastic, ceramic, or any other material capable of substantially retaining the forms of the tubes 312 and 316.

In operation, tube 312 rotates about axis 352 in angular direction 372. Tube 316 rotates about its axis 356, at substantially the same rate as tube 312 but in angular direction 376 substantially opposite angular direction 372. As tubes 312 and 316 rotate, they hinge at their respective vertices 322. If tube 312 has one or more tabs 362 or channels 364, and tube 316 has one or more channels 366 or tabs 368, then the hinging of vertices 322 is assisted by the fact that each tab 362 or channel 364 of tube 312 interfaces with each corresponding channel 366 or tube 368 of tube 316, in order to keep each vertex 322 of tube 312 temporarily hinged upon each corresponding vertex 322 of tube 316, as tubes 312 and 316 rotate. As tubes 312 and 316 rotate, they remain in contact with other, such that each surface 342 continuously temporarily comes substantially flat against a corresponding surface 342 of tube 316, then separates from corresponding surface 342 of tube 316. Simultaneously, axes 352 and 356 alternately move together when corresponding surfaces 342 come together; and axes 352 and 356 move apart from each other when corresponding surfaces 342 separate from each other.

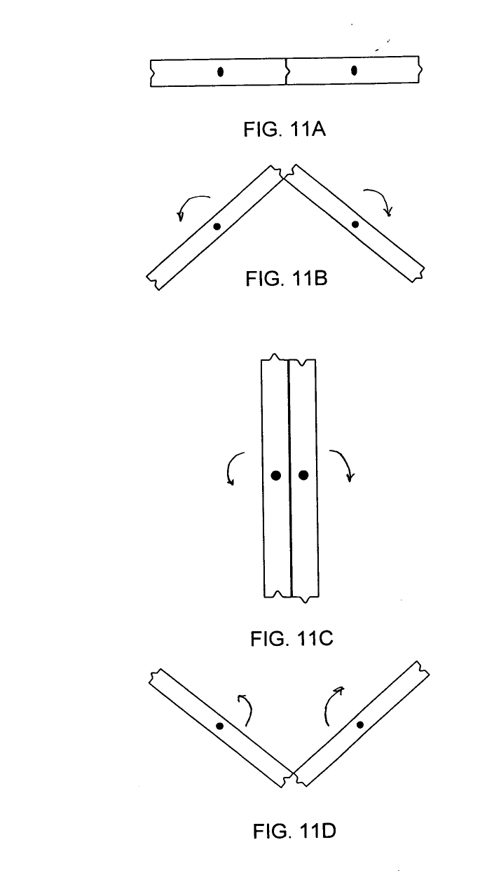

FIG. 8 is another side view of the second alternative embodiment of the rotating wing apparatus of the present invention, taken in direction 8 of FIG. 7, showing vertices 322 and two surfaces 342 of tube 316.

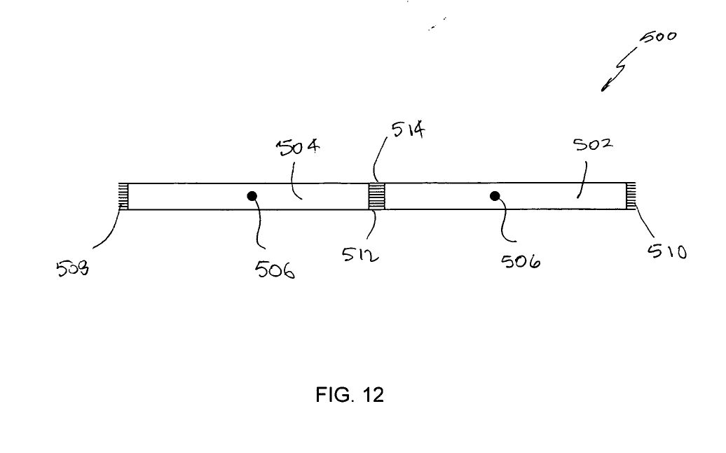

FIG. 9 is a side view of a third alternative embodiment of the rotating wing apparatus of the present invention, generally designated 400. Apparatus 400 is similar to apparatus 300 of FIG. 7 except that in FIG. 9 apparatus 400 has tubes 412 and 416 that are square in cross section instead of triangular. Each of tubes 412 and 416 has vertices 422 and surfaces 442. In FIG. 9, surfaces 442 are shown as planar. Alternatively, surfaces 442 can be wavy or any other texture or shape that allows tubes 412 and 416 to rotate and remain in contact with each other.

Tube 412 also has a central longitudinal rotational axis 452, and tube 416 has a central longitudinal rotational axis 456. Each vertex 422 of tube 412 may have either a tab 462 or channel 464 running the length of vertex 422. Each vertex 422 of tube 416 may have a channel 466 or tab 468 running the length of vertex 422 and corresponding to each tab 462 or channel 464 of tube 412.

In operation, tube 412 rotates about axis 452 in angular direction 472. Tube 416 rotates about its axis 456, at substantially the same rate as tube 412 but in angular direction 476 substantially opposite angular direction 472. As tubes 412 and 416 rotate, they hinge at their respective vertices 422. If tube 412 has one or more tabs 462 or channels 464, and tube 416 has one or more channels 466 or tabs 468, then the hinging of vertices 422 may be assisted by the fact that each tab 462 or channel 464 of tube 412 interfaces with each corresponding channel 466 or tube 468 of tube 416, in order to keep each vertex 422 of tube 412 temporarily hinged upon each corresponding vertex 422 of tube 416, as tubes 412 and 416 rotate. As tubes 412 and 416 rotate, they remain in contact with other, such that each surface 442 continuously temporarily comes substantially flat against a corresponding surface 442 of tube 416, then separates from corresponding surface 442 of tube 416. Simultaneously, axes 452 and 456 alternately move together when corresponding surfaces 442 come together; and axes 452 and 456 move apart from each other when corresponding surfaces 442 separate from each other.

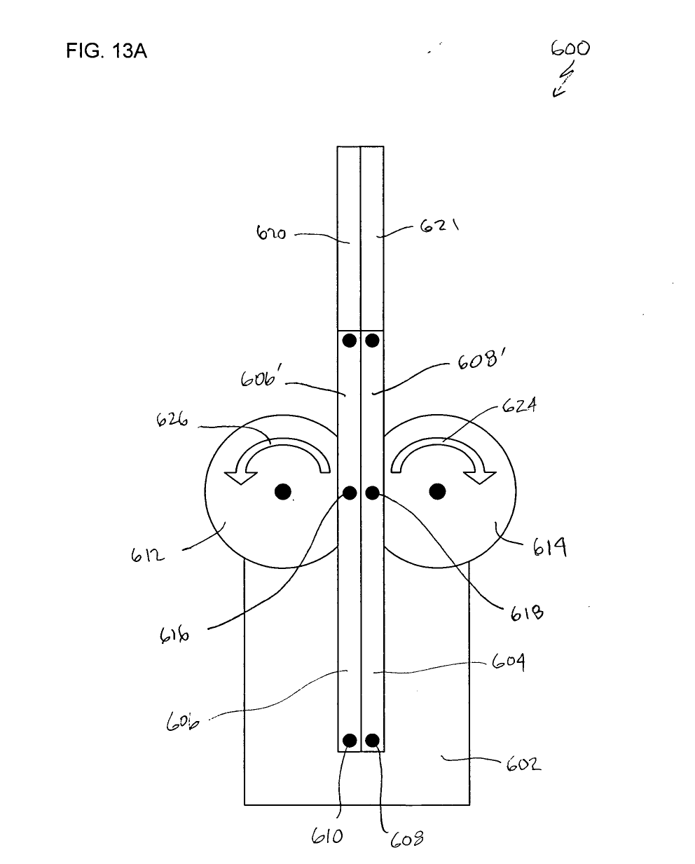

FIG. 10 is another side view of the third alternative embodiment of the rotating wing apparatus of the present invention, taken in direction 10 of FIG. 9, showing vertices 422 and a surface 442 of tube 416.

A consideration of using tubes with three or more surfaces instead of panels is that, with more sides on each tube, the pressure differentials produced in operation may be less than with fewer sides. If the number of surfaces is increased to infinity, the tubes become cylinders, which may be used in the rotating wing apparatus of the present invention, but may produce significantly lower pressure differentials than with panels.

As with the panels of FIGS. 1-6, the surfaces of the tubes of FIGS. 7-10 may have shapes and textures other than planar, such as wavy or any other texture or shape that allows the tubes to rotate and remain substantially in contact with other.

Referring now to FIG. 11, a series of views A through D are depicted and showing the operation of a preferred embodiment of the rotating wing apparatus of the present invention showing the structure that retains the panels adjacent each other during the entire rotation process. Specifically, in FIG. 11A, the two wing panels are flatly adjacent each other in their starting position. As gears are rotating in opposite directions, the panels begin to rotate away from each other along their longitudinal axes as shown in FIG. 11B. As the gears continue to rotate opposite each other; the panels rotate so that they are now in a horizontal position with their ends adjacent as shown in FIG. 11C. As the gears continue to rotate, the wing panels continue to rotate as shown in FIG. 11D towards their original position.

The gears shown in FIG. 11 are powered by a motor attached to one or both of the gears so that they rotate in opposite directions. Specifically, if one of the gears is powered, then the other gear may be driving from the first to achieve the counter-rotation necessary to maintain the wing panels in the proper alignment.

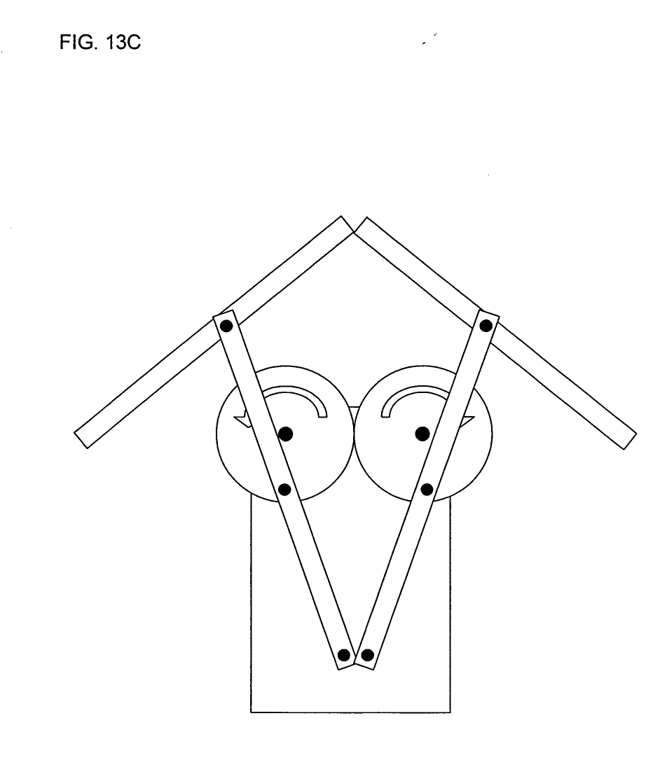

FIG. 12 is an end view of an alternative embodiment of the rotating wing apparatus of the present invention showing each panel equipped with a longitudinally placed brush which can minimize air passing between each wing panel. These brushes may provide some rotational ease yet still minimize the air passage between the panels.

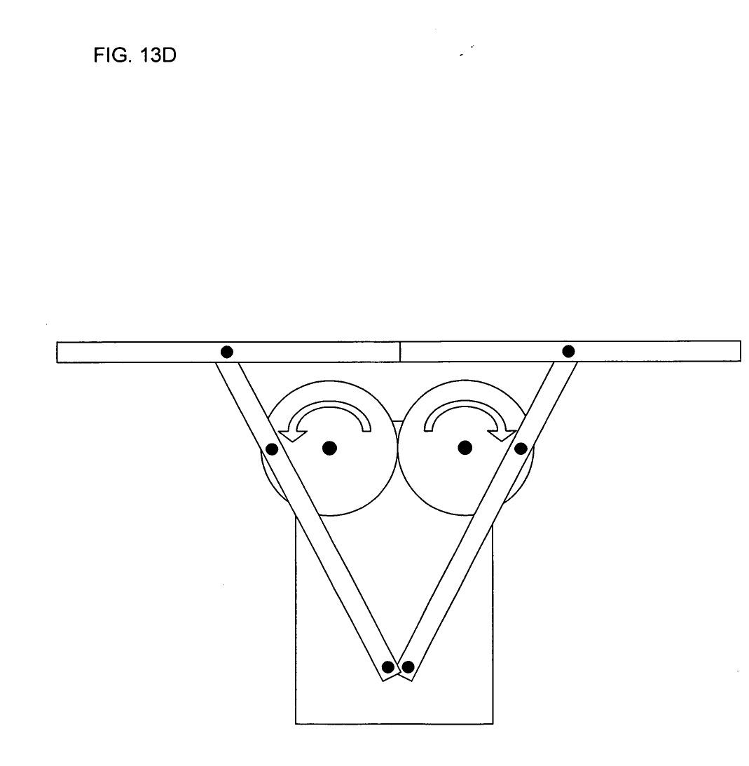

Referring now to FIGS. 13A-D, a series of progressive images showing an alternative embodiment 600 of the rotating wing apparatus of the present invention in various stages of rotation includes a chassis 602, a pair of rotating wheels 612 and 614 having a pivot point 616 and 618 on the outer rim of the wheel to engage a pin passing through a radial arm 604 and 606. The radial arms 604 and 606 extend from the chassis base 602 through the pivot point, and to the center of the wing panels 620 and 621.

As shown, the wing panels rotate in directions 624 and 626 opposite each other as controlled by the counter-rotating wheels. Because the wheels are mechanically engaged, the wing panels are rotated in precisely the same, yet opposite, position.

The present invention is in no way intended to be restricted to the description and drawings used to explain the several embodiments of the rotating wing apparatus of the present invention. The rotating wing apparatus of the present invention as described herein is not limited for use in craft, but should be extended to any equivalent inventions, such as for example, in the use of toys.

While several different embodiments of the rotating wing apparatus of the present invention are disclosed herein, it is to be appreciated that the present invention contemplates combinations of the various embodiments without departing from the spirit and scope of the present invention. Also, it is also to be appreciated that while various elements of the rotating wing apparatus of the present invention have been referred to as the “first” and “second” of such rotating wing apparatus of the present invention of the present invention, no specific configuration, order, or preference is intended. Rather, the “first” and “second” nomenclature as used herein is merely for the purposes of facilitating the description of the rotating wing apparatus of the present invention. Further, the rotating wing apparatus of the present invention as described herein may comprise more than two panels, tubes, etc. to form a more complex or more powerful apparatus.

It is also to be recognized that modifications may be made, by one of ordinary skill in the art of the invention, without departing from the intent of the rotating wing apparatus of the present invention. The scope of the present invention is to be taken as described herein as well as including all reasonable equivalents of the subject matter of the appended claims.

I claim:

1. A rotating wing apparatus, comprising:
a first planar wing panel having a longitudinal edge;
a second planar wing panel having a longitudinal edge;
a means for longitudinally rotating said first planar wing panel in a first rotational direction;
a means for longitudinally rotating said second planar wing panel in a direction opposite said first rotational direction; and
a means for retaining said first planar wing and said second planar wing together during said rotation wherein said longitudinal edges of said first and said second planar wing panel.

2. The rotating wing apparatus of claim 1, wherein said first and second planar wing panel are rectangular.

3. The rotating wing apparatus of claim 1, wherein said first and second planar wing panel have a triangular cross-section.

4. The rotating wing apparatus of claim 1, wherein said first and second planar wing panel have a rectangular cross-section.

5. The rotating wing apparatus of claim 1, wherein said means for longitudinally rotating said first planar wing panel in a first rotational direction comprises a gear rotated by a motor; and
said means for longitudinally rotating said second planar wing panel in a direction opposite said first rotational direction comprises a take-off gear from said first gear rotated by said motor.

6. The rotating wing apparatus of claim 5, wherein said motor is an electric motor.

7. The rotating wing apparatus of claim 5, wherein said motor is a gasoline-powered motor.

8. The rotating wing apparatus of claim 1, wherein said means for retaining said first and second planar wing together comprises a gear-driven wheel wherein said wheel is mechanically engaged to said panels by a chain drive mechanism.

9. The rotating wing apparatus of claim 8, wherein said chain drive mechanism maintains the angular rotation of each planar wing.

10. A rotating wing apparatus comprising:
a chassis;
a first and second lever arm having a fixed end and a distal end, wherein said fixed end is rotatably attached to said chassis;
a drive wheel for each lever arm and attached to said chassis and having a pin passing through a pivot point in said drive wheel wherein said drive wheel is rotated causing said lever arms to pivot from a first configuration wherein said lever arms are substantially parallel, to a second configuration wherein said lever arms are at an angle to each other;
a wing panel attached to each lever arm at said distal end; and
a means for rotating said wing panel in conjunction with said drive wheels wherein said wing panels are maintained in physical contact with each other.

11. The rotating wing apparatus of claim 10, wherein said means for rotating said wing panel comprises a motor.

12. The rotating wing apparatus of claim 10, wherein said means for rotating said wing panel comprises an engine.
